(19) United States
(12) Patent Application Publication
(10) Pub. No.: US 2009/0262459 A1
(43) Pub. Date: Oct. 22, 2009

(54) SLIDER OF A HARD DISK DRIVE AND HARD DISK DRIVE HAVING THE SAME

(75) Inventors: Leonid MASLOV, Yongin-si (KR); Jin Gyoo Yoo, Seongnam-si (KR); Cheol-Soon Kim, Anyang-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/427,992

(22) Filed: Apr. 22, 2009

(30) Foreign Application Priority Data
Apr. 22, 2008 (KR) 10-2008-0037363

(51) Int. Cl. G11B 5/60

(52) U.S. Cl. 360/234.3; G9B/5.23

(57) ABSTRACT

A slider of a hard disk drive can include a slider main body on which a read/write head is mounted, the read/write head configured to write data to a disk and to read data from the disk by being lifted a predetermined height from a surface of the disk by a lift force when the disk is rotating, and a lift force generation unit provided in an area of the slider main body proximate to the read/write head to improve the lift force of the slider main body with respect to the disk.

### CROSS-REFERENCE TO RELATED APPLICATIONS

This application claims the benefit of Korean Patent Application No. 10-2008-0037363, filed on Apr. 22, 2008, in the Korean Intellectual Property Office, the disclosure of which is incorporated herein in its entirety by reference.

### BACKGROUND

1. Field of the Inventive Concept

The inventive concept relates to a slider of a hard disk drive (HDD) and an HDD having the same, and more particularly, to a slider of a hard disk drive (HDD) which can provide fast and smooth unloading of a read/write head from a disk, and an HDD having the same.

2. Description of the Related Art

HDDs are data storage devices capable of recording data on a disk and/or reproducing data stored on the disk using a read/write head. HDDs are widely used as auxiliary memory devices of computer systems because of their fast access time to a large amount of data for recording or reproduction.

As HDDs having a high TPI (tracks per inch) and a high BPI (bits per inch) have been developed, an increase in the data storage capacity and a decrease in the size of HDDs have been rapidly realized. Also, the application of the HDD has been expanded to laptops, MP3 players, mobile communication terminals, etc. Accordingly, there has been an increase in the development of compact HDDs which can be used with portable electronic products such as notebooks, personal digital assistants (PDAs), and mobile phones. Recently, HDDs having a diameter of 2.5 inches have been developed and applied for use with notebooks. Also, smaller HDDs having a diameter of 0.8 inches, which is similar to the size of a coin, have been recently developed and are being used or expected to be used, for mobile phones or MP3 players.

HDDs generally include a disk pack having at least one disk that is rotatably supported on a shaft, a head stack assembly in which a read/write head for recording and reproducing data with respect to the disk is installed on a tip end thereof, a voice coil motor for driving the head stack assembly, a printed circuit board assembly, a base, and a cover. The head stack assembly includes an actuator arm pivoting around a pivot shaft, a head gimbal installed at an end portion of the actuator arm and performing recording and reproduction of data with respect to the disk, a pivot shaft holder holding the pivot shaft such that the actuator arm can rotate around the pivot shaft, and a bobbin provided at a position opposite to the actuator arm with respect to the pivot shaft holder.

Referring to FIG. 1, a head gimbal 150 includes a suspension 157, a flexure 156 coupled to the suspension 157, and a slider 190 coupled to the flexure 156 and having a read/write head 191 mounted on a lower side of a tip end portion of the slider 190. In this structure, during the data recording and reproduction operation, a lift force due to the rotation of a disk 111 and an elastic force due to the suspension 157 are applied to the slider 190 on which the read/write head 191 is mounted. Accordingly, when the disk 111 is rotating, the slider 190 is lifted above a data zone of the disk 111 and maintained at a height where the lift force and the elastic force are balanced. In such state, while maintaining a constant distance from the disk 111 that is rotating, the read/write head 191 mounted on the slider 190 records and reproduces data with respect to the disk 111.

However, when power is off and the rotation of the disk 111 is stopped, the lift force lifting the slider 190 disappears such that the slider may contact and damage the data zone of the disk 111. Thus, to prevent such a damage, the slider 190 is set to be moved out of the data zone of the disk 111 prior to the contact. That is, by pivoting an actuator arm (not illustrated) to move the slider 190 to a predetermined parking zone before the rotation of the disk 111 is completely stopped, the read/write head 191 is accommodated in the parking zone so that the data zone may be prevented from being damaged even when the rotation of the disk 111 is completely stopped.

In general, in the HDD configured as above, when the power is cut off so that the rotation of the disk 111 is stopped, the read/write head 191 mounted on the slider 190 is moved to the parking zone and parked therein before the rotation of the disk 111 is completely stopped.

When the power is applied to the HDD, since the disk 111 is rotated at high speed, a sufficient lift force can be obtained to have the read/write head 191 lifted above the surface of the disk 111. However, when the power is off, or the rotation of the disk 111 is not sufficiently fast, so that a sufficient lift force to have the read/write head 191 lifted above the surface of the disk 111 may not be obtained, a head/disk interface (HDI) is generated between the read/write head 191 and the disk 111 so that a defect may be generated on the surface of the disk 111.

In particular, when the power is off and the read/write head 191 is unloaded from the disk 111 and moved to the parking zone, the HDI is highly likely to be generated due to the decrease in the lift force and a pitch static attitude (PSA). Thus, the read/write head 191 may be damaged or a defect may be generated on the surface of the disk 111 so that a long unloading time may be needed. Furthermore, the reliability in the data reading and reproduction of the read/write head 191 with respect to the disk 111 of the HDD may be deteriorated.

### SUMMARY

The present general inventive concept provides a slider of a hard disk drive (HDD) capable of parking a read/write head faster than a conventional slider by reducing a head/disk interface (HDI) when the read/write head is unloaded from a disk, and an HDD having the slider.

The present general inventive concept can also provide a slider capable of maintaining a lift force by preventing the HDI when the rotation of a disk is decelerated, in particular, when a read/write head is unloaded from the disk and moved to a parking zone of the disk, and an HDD having the slider.

Additional embodiments of the present general inventive concept will be set forth in part in the description which follows and, in part, will be obvious from the description, or may be learned by practice of the general inventive concept.

An example embodiment of the present general inventive concept provides a slider of a hard disk drive including a slider main body on which a read/write head is mounted, the read/write head configured to write data to a disk and to read data from the disk while being lifted a predetermined height from a surface of the disk by a lift force when the disk is rotating, and a lift force generation unit provided in an area of the slider main body proximate to the read/write head to improve the lift force of the slider main body with respect to the disk.

The lift force generation unit may be provided at a leading end farther than the read/write head with respect to the slider main body.

A lower surface of the lift force generation unit may be substantially flat to increase a contact surface with an air flow generated during the rotation of the disk.

The lower surface of the lift force generation unit and a lower surface of the slider main body may be substantially parallel to each other.

The height from a surface of the disk to the lowest end side of the lift force generation unit may be greater than that from the surface of the disk to the lowest end side of the slider main body.

A minimal separation distance H in a vertical direction between the lower surface of the slider main body and the lower surface of the lift force generation unit may be calculated by an equation that H=L×tan θ, wherein “θ” is an angle between a lower surface of the slider and a horizontal surface of the disk assuming that the read/write head contacts the disk and “L” is a length of the lift force generation unit in a lengthwise direction of the slider.

The lift force generation unit may be integrally formed in the slider main body.

The lift force generation unit may be coupled to the slider main body to provide an auxiliary lift force.

An air bearing unit may be formed on the lower surface of the slider main body to assist the lift of the slider main body as the air flow is generated during the rotation of the disk.

The air bearing unit may be formed by a sunken rail of a non-linear type that is sunken in the widthwise direction of the slider main body from the lower surface of the slider, and the sunken rail may include one end that is blocked and the other end connected to the side surface of the slider main body to allow the air flow incoming through the sunken rail to exit outside the slider main body.

A head mounting unit may be further formed at the center of the lower surface of the slider main body in a lengthwise direction of the slider and may have an end portion on which the read/write head is mounted, and the air bearing unit may be symmetrically provided at both sides of the lower surface of the slider main body with respect to the head mounting unit.

Exemplary embodiments of the present general inventive concept also provide a hard disk drive including a disk on and from which data is recorded and reproduced, and a slider comprising a slider main body on which a read/write head is mounted, the read/write head configured to write data to the disk and to read data from the disk while being lifted a predetermined height from a surface of the disk, and a lift force generation unit provided in an area of the slider main body proximate to the read/write head to improve a lift force of the slider main body with respect to the disk.

The lift force generation unit may be provided at a leading end farther than the read/write head with respect to the slider main body.

A lower surface of the lift force generation unit may be substantially flat to increase a contact surface with an air flow generated during the rotation of the disk.

The lower surface of the lift force generation unit and a lower surface of the slider main body may be substantially parallel to each other.

The height from a surface of the disk to the lowest end side of the lift force generation unit may be greater than that from the surface of the disk to the lowest end side of the slider main body.

A minimal separation distance H in a vertical direction between the lower surface of the slider main body and the lower surface of the lift force generation unit may be calculated by an equation that H=L×tan θ, wherein “θ” is an angle between a lower surface of the slider and a horizontal surface of the disk assuming that the read/write head contacts the disk and “L” is a length of the lift force generation unit in a lengthwise direction of the slider.

The lift force generation unit may be integrally formed in the slider main body.

The lift force generation unit may be coupled to the slider main body to provide an auxiliary lift force.

An air bearing unit may be formed on the lower surface of the slider main body to assist the lift of the slider main body as the air flow is generated during the rotation of the disk.

The air bearing unit may be formed by a sunken rail of a non-linear type that is sunken in the widthwise direction of the slider main body from the lower surface of the slider, and the sunken rail may include one end that is blocked and the other end connected to the side surface of the slider main body to allow the air flow incoming through the sunken rail to exit outside the slider main body.

A head mounting unit may be further formed at the center of the lower surface of the slider main body in a lengthwise direction of the slider and may have an end portion on which the read/write head is mounted, and the air bearing unit may be symmetrically provided at both sides of the lower surface of the slider main body with respect to the head mounting unit.

Exemplary embodiments of the present general inventive concept can also provide a head stack assembly (HSA) of a hard disk drive, including a read/write head to read data from a disk and to write data to the disk, a slider connected to the read/write head to receive a lift force of the disk to lift the read/write head above the disk when the disk is rotating, and a lift force generation unit coupled to the slider to provide an auxiliary lift force of the disk to the slider when the rotation of the disk decelerates.

The lift force generation unit can provide the auxiliary lift force as the read/write head moves closer to the disk.

The lift force generation unit may not substantially change the lift force when the read/write head is disposed a predetermined height above the disk.

The slider can form a first angle with respect to the disk when the disk is rotating at a predetermined speed such that the lift force generation unit does not substantially change the lift force received by the slider, and the slider can form a second angle with respect to the disk when the disk is rotating at a speed less than the predetermined speed such that the lift force generation unit changes the lift force by providing the auxiliary lift force to the slider.

### BRIEF DESCRIPTION OF THE DRAWINGS

Exemplary embodiments of the present general inventive concept will be more clearly understood from the following detailed description taken in conjunction with the accompanying drawings in which:

FIG. 1 schematically illustrates the structure of a head gimbal of a conventional HDD;

FIG. 2 is a perspective view of an HDD according to an exemplary embodiment of the present general inventive concept;

FIG. 3 schematically illustrates the structure of a head gimbal according to an exemplary embodiment of the present general inventive concept;

FIG. 4 illustrates the coupling position of a lift force generation unit with respect to the slider of FIG. 3;

FIG. 5A illustrates a state in which the slider is lifted during the rotation of the disk in a normal operation state of the HDD according to an exemplary embodiment of the present general inventive concept;

FIG. 5B illustrates a state in which the read/write head is lifted with respect to the disk when the read/write head is unloaded from the disk in the HDD according to an exemplary embodiment of the present general inventive concept;

FIG. 6 is a bottom view of the slider and the lift force auxiliary unit of FIG. 3;

FIG. 7 is a perspective view of FIG. 6;

FIG. 8 is a graph illustrating the clearance between the read/write head and the disk between the conventional slider and the slider according to an exemplary embodiment of the present general inventive concept;

FIGS. 9, 10A, and 10B are graphs illustrating that the safe area of PSA and the RSA of the slider according to an exemplary embodiment of the present general inventive concept have been improved from those of the conventional slider;

FIG. 11 is a graph illustrating that the unload velocity of the read/write head of the slider according to an exemplary embodiment of the present general inventive concept has been improved from that of the read/write head of the conventional slider; and

FIG. 12 is a graph comparing the ramp force and the lift-off force between the conventional slider and the slider according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

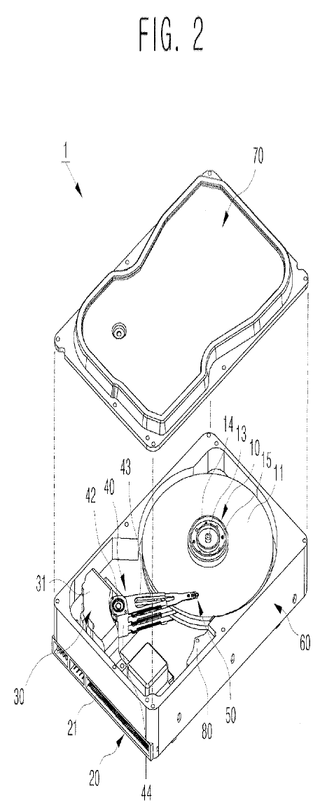

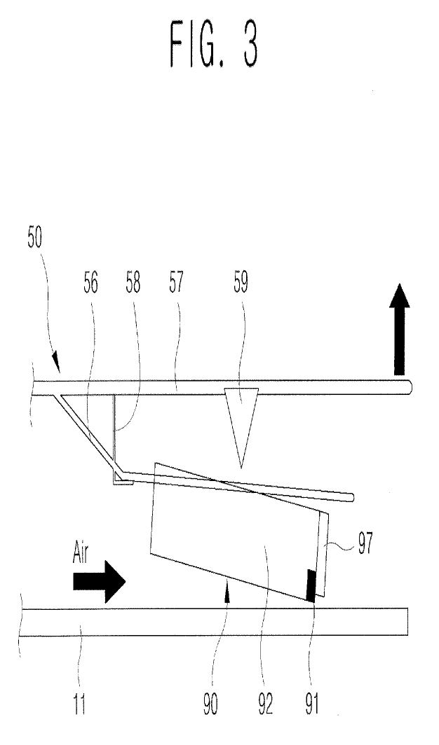

FIG. 2 is a perspective view of a hard disk drive (HDD) 1 according to an exemplary embodiment of the present general inventive concept. Referring to FIG. 2, the HDD 1 can include a disk pack 10, a printed circuit board assembly (PCBA) 20, a voice coil motor (VCM) 30, a cover 70, a base 60 coupled to the cover 70, and a head stack assembly (HSA) 40 having a head gimbal 50 in which a read/write head 91 (refer to FIG. 3) is installed at an end portion thereof. The above-described elements can be installed on the base 60. The cover 70 can be coupled to the base 60 to protect the elements installed on the base 60.

The disk pack 10 can include a plurality of disks 11 vertically arranged, a shaft 13 to form a rotation shaft of the disks 11, a spindle motor hub (not illustrated) provided radially outside the shaft 13 to support the disks 11, a spindle motor (not illustrated) to rotate the spindle motor hub, a clamp 14 coupled to an upper portion of the spindle motor hub, and a clamp screw 15 to press the clamp 14 and to fix the disks 11 to the spindle motor. According to the above structure, the disks 11 can be rotated and thus a lift force to lift the read/write head 91 above the surface of each of the disks 11 can be generated.

The PCBA 20 can include a printed circuit board (PCB; not illustrated) having a plate shape coupled to a rear surface of the base 60, a flexible printed circuit board (FPCB; not illustrated) installed on the upper surface of the base 60 proximate to the HSA 40 and to electrically connect the HSA 40 and the PCB, and a PCB connector 21 provided at one side of the PCB. A plurality of chips (not illustrated) can be installed on the PCB to control the disk pack 10, the HSA 40, and the VCM 30 and to transceive an external signal via the PCB connector 21.

The VCM 30 functions as a drive motor to pivot an actuator arm 43 of the HSA 40 in a predetermined direction to move the read/write head 91 to a desired position on the disks 11. The VCM 30 can include a VCM block 31 having a magnet (not illustrated) and a voice coil (not illustrated) installed on a bobbin (not illustrated).

The VCM 30 can use Fleming's left hand rule, that is, a principle that an electromagnetic force can be generated when current flows in a conductive body placed in a magnetic field. Thus, when current is applied to the voice coil placed between the magnets, a force can be generated and applied to the bobbin so that the bobbin may pivot. Accordingly, since the actuator arm 43 can pivot in the predetermined direction, the read/write head 91 installed at an end portion of the actuator arm 43 can be moved in a radial direction of the rotating disks 11. As a result, the read/write head 91 may seek and access a track to write data to the disks 11 and/or to read data from the disks 11 as the read/write head 91 moves across the disks 11.

The HSA 40 can be configured in the form of a carriage to record data on the disks 11 or to reproduce data from the disks 11. The HSA 40 can include the head gimbal 50 having a slider 90 (refer to FIG. 3) on which the read/write head 91 can be mounted to write data to the disks 11 or to reproduce data from the disks 11, the actuator arm 43 can be coupled to the head gimbal 50 to pivot around a pivot shaft 42 across the disks 11, a pivot shaft holder 44 to hold the pivot shaft 42 so that the actuator arm 43 may pivot around the pivot shaft 42, and the bobbin can be provided at the opposite side of the actuator arm 43 with respect to the pivot shaft holder 44.

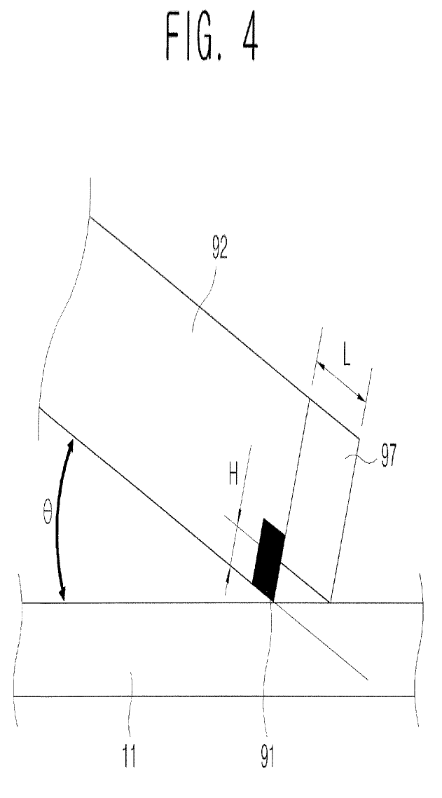

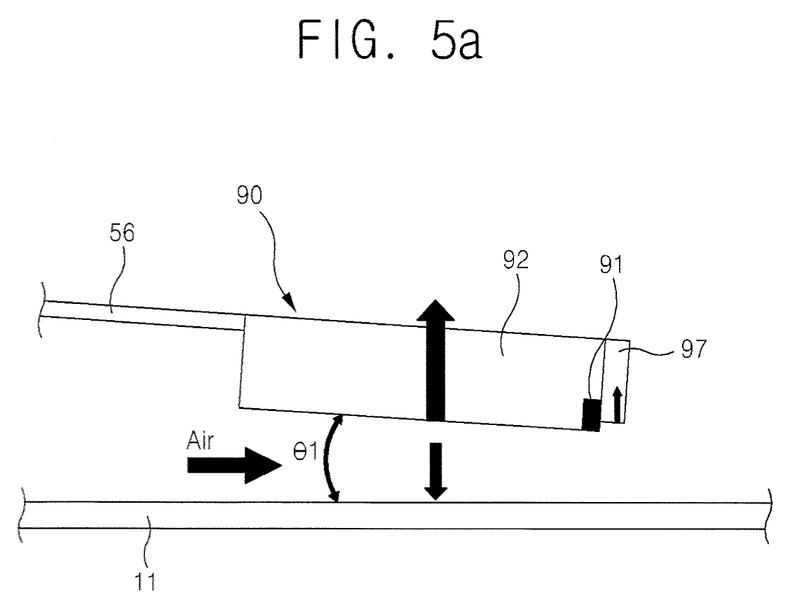

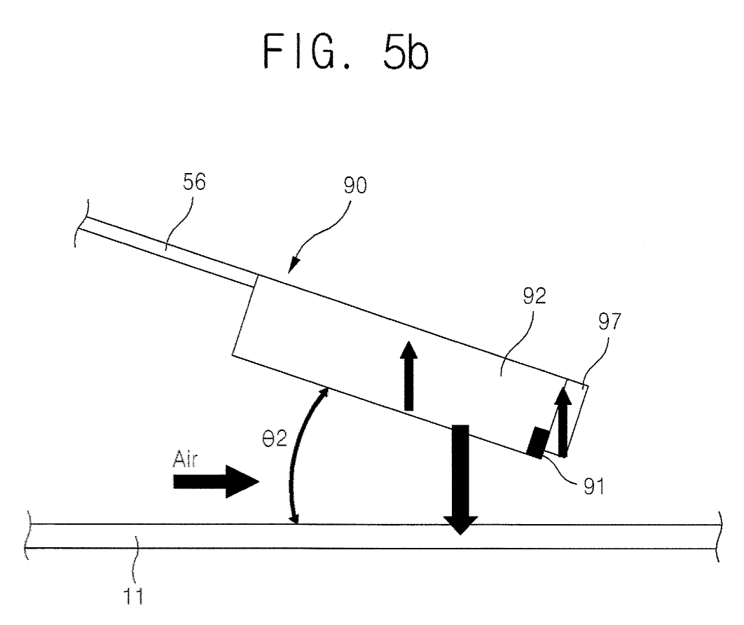

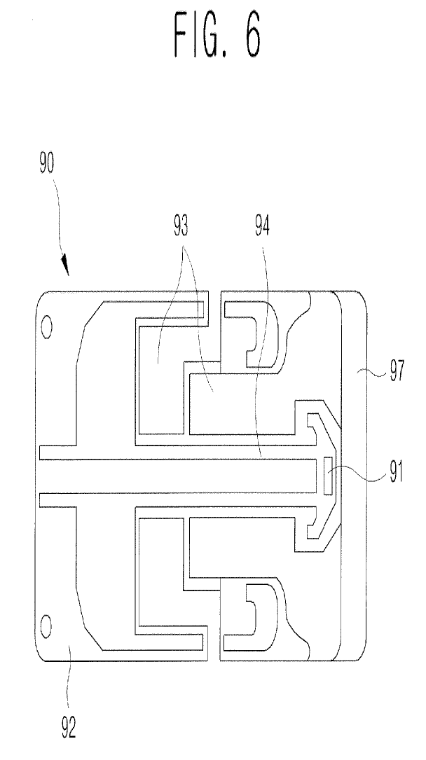

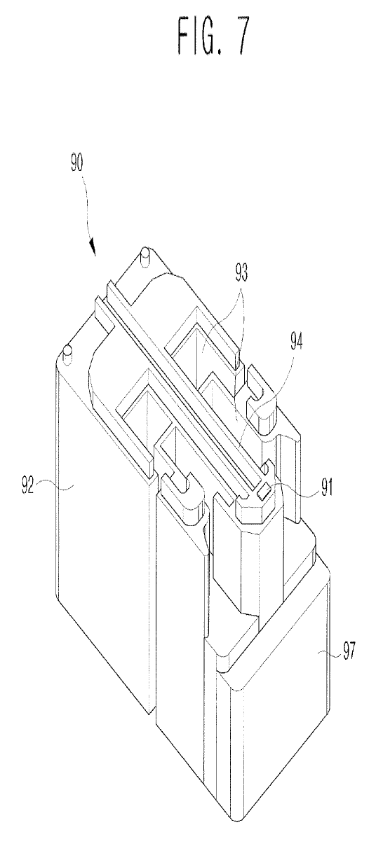

FIG. 3 schematically illustrates the structure of a head gimbal according to an exemplary embodiment of the present general inventive concept. FIG. 4 illustrates a coupling position of a lift force generation unit 99 with respect to the slider 90 of FIG. 3. FIG. 5A illustrates a state in which the slider 90 is lifted during the rotation of the disk 11 in a normal operation state of the HDD according to an exemplary embodiment of the present general inventive concept. FIG. 5B illustrates a state in which the read/write head 91 is lifted with respect to the disk 11 when the read/write head 91 is unloaded from the disk 11 in the HDD according to an exemplary embodiment of the present general inventive concept. FIG. 6 is a bottom view of the slider 90 and the lift force generation unit of FIG. 3. FIG. 7 is a perspective view of FIG. 6.

Referring to FIGS. 3-7, the head gimbal 50 according to an exemplary embodiment of the present general inventive concept can include the slider 90 on which the read/write head 91 can be mounted, the flexure 56 coupled to the slider 90 and supported by a suspension 57 coupled to the flexure 56.

The read/write head 91 can be coupled to a head mounting unit 94 formed on the lower surface of the slider 90 as illustrated in FIGS. 6 and 7. The read/write head 91 can read or write information with respect to the disks 11 that are rotating by detecting a magnetic field formed on the surface of each of the disks 11 or by magnetizing the surface of each of the disks 11. For example, the read/write head 91 can include a read head to detect the magnetic field of the disks 11 and a write head to magnetize the disks 11, to perform the recording and reproduction of data.

The flexure 56, which can be coupled to the slider 90 to support the slider 90, can have one end coupled to one surface of the suspension 57 facing the disks 11 and another end in which the slider 90 having the read/write head 91 mounted thereon is installed. A dimple 59 and a limiter 58 can be coupled to the suspension 57 as illustrated in FIG. 3, to restrict upward and downward movements of the flexure 56, that is, in directions away and toward the disks 11.

The dimple 59 can restrict the distance that the slider 90 is separated from the disks 11, thus preventing the deterioration of the data recording and reproduction operations of the read/write head 91 to the disks 11. The limiter 58 can restrict the flexure 56 from being excessively separated from the suspension 57 so that the slider 90 which is coupled to the flexure 56 can be restricted from being excessively close to the disks 11. Thus, the generation of a head/disk interface (HDI) can be prevented.

The suspension 57, to which the flexure 56 is coupled, can be elastically biased so that the slider 90 may be moved toward and away from the surface of each of the disks 11. An end tap (not illustrated) may be provided at an end portion of the suspension 57, which can be parked on a ramp 80 when power is off. A method of parking the end tap 57a on the ramp 80 can be referred to as a ‘ramp method.’

As illustrated in FIGS. 6 and 7, the slider 90 can include a slider main body 92 on which the read/write head 91 is mounted. A lift force generation unit 97 can be provided at a leading end portion of one side of the slider main body 92 to improve a lift force of the read/write head 91 with respect to the disks 11.

An air bearing surface (ABS) 93 to lift the slider 90 above the disks 11 can be provided at the lower surface of the slider main body 92. That is, as described above, when the disks 11 are rotated at high speeds, a lift force to lift the slider 90 can be generated due to the friction between air and the surface of each of the disks 11. Accordingly, as illustrated in FIG. 3, the read/write head 91 can be maintained above the data zone of each of the disks 11 at a height at which the lift force is balanced with the elastic force by the suspension 57 so that the data may be recorded or reproduced with respect to the disks 11.

Referring to FIGS. 6 and 7, the ABS 93 can be formed by a sunken rail 93 sunken from the lower surface of the slider main body 92 in the thicknesswise direction of the slider main body 92. The sunken rail 93 can be formed in a non linear shape. The ABS 93 (sunken rail 93) can be symmetrically provided in the slider main body 92 with respect to the head mounting unit 94. However, it is understood that the structure of the ABS 93 which is formed by the sunken rail 93 in accordance with an exemplary embodiment of the present general inventive concept is not limited to the illustrated example, and that other shapes and structures capable of lifting the slider 90 above the disks 11 may be employed without departing from the broaden principles and spirit of the present general inventive concept.

In the illustrated example embodiment of FIG. 7 in which one end of the sunken rail 93 is blocked and the other end is open at the side of the slider main body 92, air flow coming in the sunken rail 93 can press against the slider main body 92 in a direction separated from the disks 11 so as to remain in the sunken rail 93 for a predetermined time. Thus, the lift force of the slider 90 may be maintained. Also, the head mounting unit 94 on which the read/write head 91 is mounted can be provided in the center area of the lower surface of the slider main body 92 in the lengthwise direction of the slider 90.

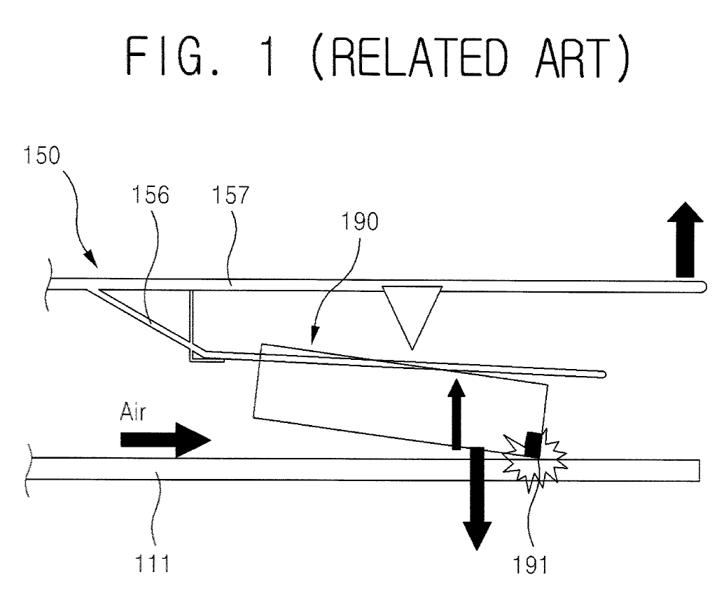

As described above, when power is applied to the conventional HDD, the disk 111 of FIG. 1 can rotate at a relatively high speed so that a sufficient lift force to lift the slider 190 above the disk 111 may be generated. However, when the power is off so that the rotation speed of the disk 111 is decreased, the actuator arm can pivot to be unloaded in the parking zone at the ramp installed close to the outer circumference of the disk 111, as illustrated in FIG. 1. As a result, the HDI may be generated due to decrease in the lift force and a pitch static attitude (PSA).

However, according to example embodiments of the present general inventive concept, the slider 90 can be configured to include the lift force generation unit 97 to compensate for the decrease in the lift force and the PSA. Accordingly, when the read/write head 91 is loaded on the ramp, an auxiliary lift force of the slider 90 and a negative force can be generated.

In the exemplary embodiments of the present general inventive concept, the lift force generation unit 97 can be coupled to the front surface of the leading end portion of the slider 90, on which the read/write head 91 is installed, and substantially parallel to each other such that the contact area with the air flow generated during the rotation of the disks 11 may increase. However, although the lower surface of the slider main body 92 and one surface of the lift force generation unit 97 facing the disks 11 can be substantially parallel to each other, the slider main body 92 and the lift force generation unit 97 can be provided to be stepped from each other such that the lower surface of the slider main body 92 may be closer to the surface of each of the disks 11 than the one surface of the lift force generation unit 97. That is, the lift force generation unit 97 can be stepped from the slider main body 92 such that the height from the surface of each of the disks 11 to the lowermost side of the lift force generation unit 97 is larger than the height from the surface of each of the disks 11 to the lowermost side of the slider main body 92.

For example, as illustrated in FIG. 4, the position of the lift force generation unit 97 which is coupled to the slider main body 92 can be determined according to the length L of the lift force generation unit 97 in the lengthwise direction of the slider main body 92. The minimal separation distance H between the lower surface of the leading end portion of the slider main body 92 and the lower surface of the lift force generation unit 97 may be obtained by multiplying the length L of the lift force generation unit 97 by a value “tan θ” that is obtained by substituting an angle θ between the lower surface of the slider main body 92 and the surface of each of the disks 11 when the read/write head 91 contacts the surface of each of the disks 11 in tangent (tan). The minimal separation distance H can be expressed by an equation “H=L×tan θ”. However, to prevent one point of the lift force generation unit 97 from contacting the disks 11 when the read/write head 91 contacts the disks 11, the minimal separation distance H may be configured greater than L×tan θ.

The lift force generation unit 97 configured in accordance with the exemplary embodiments does not generate a relatively large auxiliary lift force in a normal lift state, and does not materially change the lift characteristic of the slider 90 in a normal lift state. However, during unloading, the lift force generation unit 97 may generate a relatively large lift force so that the HDI generated during unloading may be avoided.

For example, as illustrated in FIG. 5A, in a normal lift state, that is, when power is applied and the disks 11 rotate at a relatively high speed, a relatively large auxiliary lift force can be avoided since a dynamic pitch angle θ1 can be made relatively small compared to θ2 of FIG. 5B, with results being that the lift characteristic of the slider 90 may not be materially changed.

However, as illustrated in FIG. 5B, when the power is off, that is, when the read/write head 91 is unloaded and moved to the ramp 80 as described above, a relatively large auxiliary lift force can be generated since the dynamic pitch angle θ2 is relatively large compared to θ1 of FIG. 5A (since the read/write head 91 is closer to the surface of each of the disks 11), with results being that the HDI may be avoided.

The slider main body 92 and the lift force generation unit 97 of the present general inventive concept may be integrally provided by injection molding. For example, when the slider 90 and the lift force generation unit 97 are integrally formed of plastic or ceramic, the ABS 93 of the slider main body 92 may be provided by etching. However, it is understood that although the slider main body 92 and the lift force generation unit 97 can be integrally provided, the slider main body 92 and the lift force generation unit 97 may be separately manufactured and then coupled to each other to achieve the same or similar results.

As described above, by providing the lift force generation unit 97 to improve the lift force at the leading end surface of one side of the slider main body 92, that is, at the leading end farther than the read/write head 91 with respect to the slider main body 92, the read/write head 91 may be parked faster compared to the conventional technology by reducing the HDI during unloading of the read/write head 91 from the disk 11, without materially affecting the lift characteristic of the slider 90 in the normal lift state.

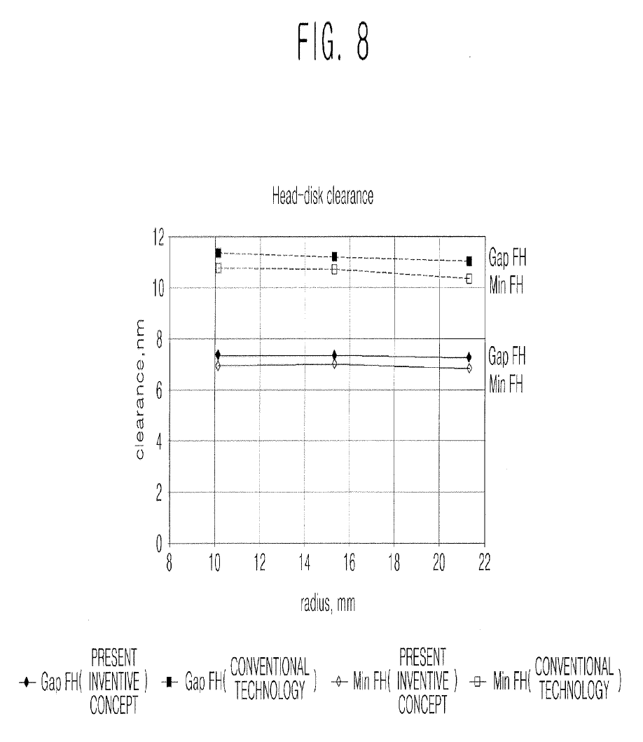

FIG. 8 is a graph illustrating the clearance between the read/write head and the disk with respect to a conventional slider and a slider configured in accordance with an exemplary embodiment of the present general inventive concept. In FIG. 8, it can be seen that the read/write head 91 according to an exemplary embodiment of the present general inventive concept can maintain a flying height (FH) lower than that of the conventional read/write head 191 (refer to FIG. 1) which does not include the lift force generation unit 97. As illustrated in FIG. 8, it is apparent that the reliability of reproducing data stored on the disks 11 or recording data on the disks 11 can be improved compared to the conventional technology.

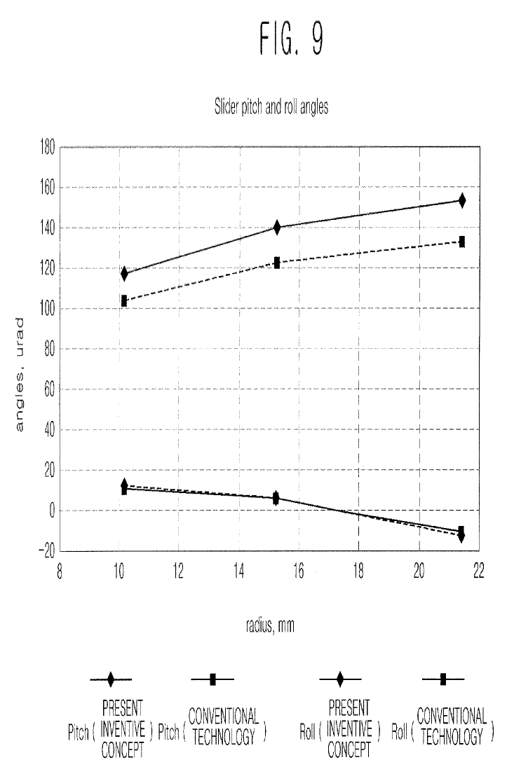

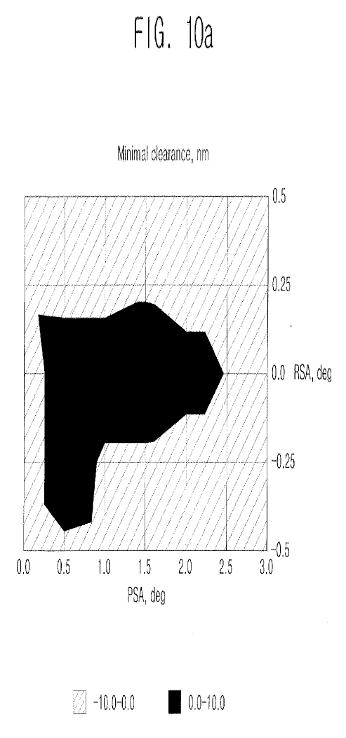

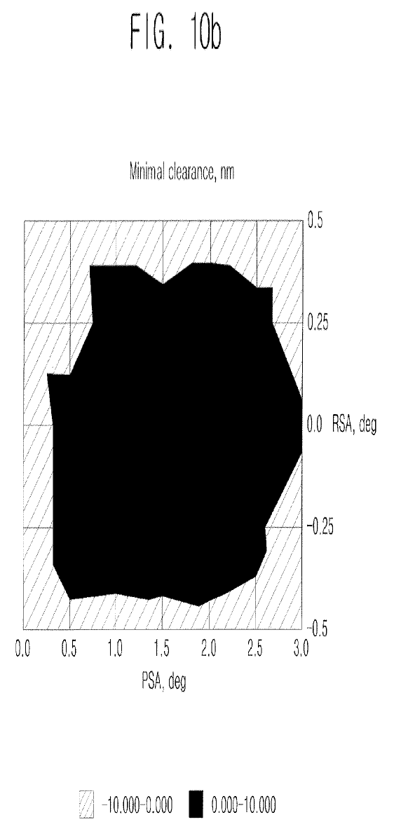

FIGS. 9, 10A, and 10B are graphs illustrating that the safe area of PSA and a roll static attitude (RSA) of the slider according to an exemplary embodiment of the present general inventive concept have been improved from those of the conventional slider. In particular, as it can be seen from the comparison between FIG. 10A illustrating the PSA and the RSA of the conventional slider and FIG. 10B illustrating the PSA and the RSA according to the slider according to an exemplary embodiment of the present general inventive concept, the movement range in the up and down and the left and right directions with respect to the center of the slider 90 is increased compared to the conventional technology, with results being that the HDI may be reduced. For reference, the PSA and the RSA refer to a pitch angle and a roll angle, respectively, and are used as indexes to indicate the movement range of the slider 90.

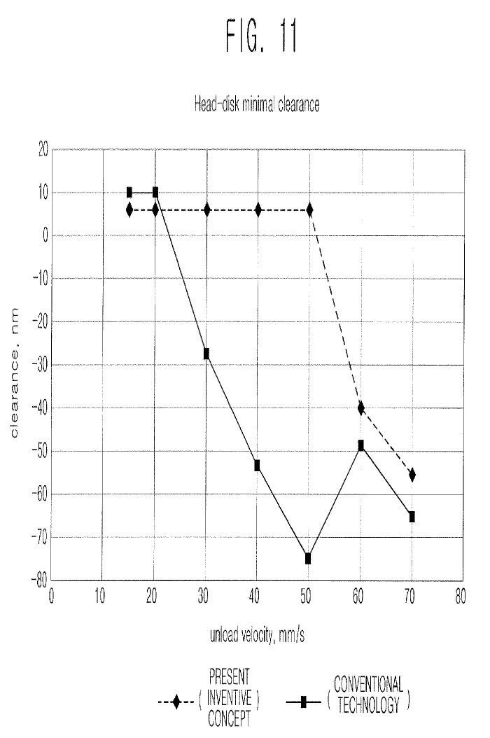

FIG. 11 is a graph illustrating that the unload velocity of the read/write head of the slider according to an exemplary embodiment of the present general inventive concept has been improved from that of the read/write head of the conventional slider. Referring to FIG. 11, when the unload velocity is approximately 22 mm/s or more, the HDI is generated in the slider 90 according to the conventional slider. However, in the slider configured in accordance with an exemplary embodiment of the present general inventive concept, the HDI is not generated until at least 50 mm/s.

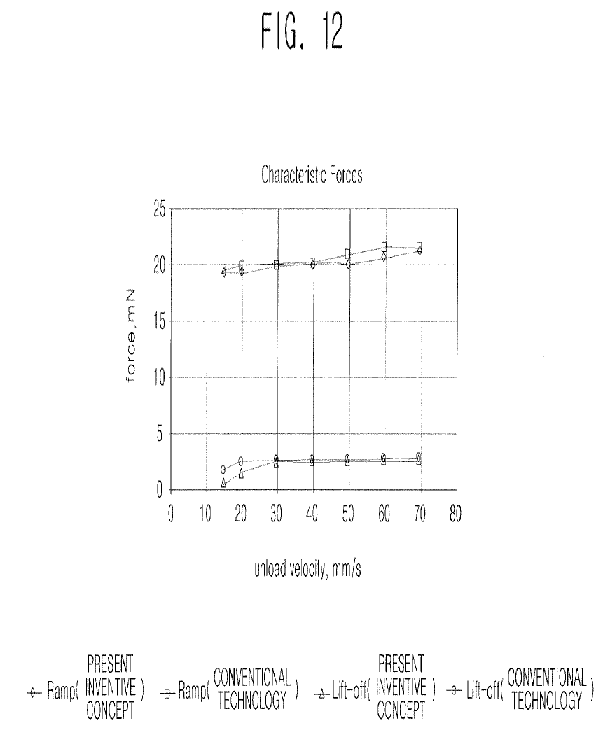

FIG. 12 is a graph comparing the ramp force and the lift-off force between the conventional slider and the slider according to an exemplary embodiment of the present general inventive concept. Referring to FIG. 12, it can be seen that when the unload velocity is about 20 mm/s, a ramp force is approximately less than 2.8% and a lift-off force is approximately less than 54%.

According to an exemplary embodiment of the present general inventive concept, when the rotation speed of the disks 11 is decreased, in particular, when the read/write head 91 is unloaded from the disks 11 and moved to be parked, the generation of the HDI can be reduced compared to the conventional technology so that the read/write head 91 may be quickly parked.

In the above-described embodiments, the slider may be any one of a full slider, a mini slider, a nano slider, a pico slider, and pemto slider. For a compact HDD having a diameter of 1.8 inches, to maintain the FH between a disk surface and a read/write head by several to tens of micrometers, a nano slider having a volume of 1.6×2.0×0.425 (W×L×H) mm3 or a pico slider having a volume of 1.0×0.2×0.3 (W×L×H) mm3 and a suspension appropriate for the generation of a seek speed required for the volume may be employed. For a mid-sized HDD having a diameter of 2.5 inches, a pemto slider having a volume of 0.7×1.2×0.23 (W×L×H) mm3 may be employed in addition to the pico slider having a volume of 1.0×1.2×0.3 (W×L×H) mm3.

As described above, according to the present general inventive concept, the read/write head can be parked faster than a conventional read/write head by reducing the HDI when the read/write head is unloaded from the disk.

Although a few example embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A slider of a hard disk drive comprising:
a slider main body on which a read/write head is mounted, the read/write head configured to write data to a disk and to read data from the disk by being lifted a predetermined height from a surface of the disk by a lift force when the disk is rotating; and
a lift force generation unit provided in an area of the slider main body proximate to the read/write head to improve the lift force of the slider main body with respect to the disk.

2. The slider of claim 1, wherein the lift force generation unit is provided at a leading end farther than the read/write head with respect to the slider main body.

3. The slider of claim 1, wherein a lower surface of the lift force generation unit is substantially flat to increase a contact surface with an air flow generated during the rotation of the disk.

4. The slider of claim 3, wherein the lower surface of the lift force generation unit and a lower surface of the slider main body are substantially parallel to each other.

5. The slider of claim 4, wherein the height from a surface of the disk to the lowest end side of the lift force generation unit is greater than that from the surface of the disk to the lowest end side of the slider main body.

6. The slider of claim 5, wherein a minimal separation distance H in a vertical direction between the lower surface of the slider main body and the lower surface of the lift force generation unit is calculated by an equation of:
H=L×tan θ,
wherein “θ” is an angle between a lower surface of the slider and a horizontal surface of the disk assuming that the read/write head contacts the disk and “L” is a length of the lift force generation unit in a lengthwise direction of the slider.

7. The slider of claim 1, wherein the lift force generation unit is integrally formed in the slider main body.

8. The slider of claim 1, wherein the lift force generation unit is coupled to the slider main body to provide an auxiliary lift force.

9. The slider of claim 1, wherein an air bearing unit is formed on the lower surface of the slider main body to assist the lift of the slider main body as the air flow is generated during the rotation of the disk.

10. The slider of claim 9, wherein the air bearing unit is formed by a sunken rail of a non-linear type that is sunken in the widthwise direction of the slider main body from the lower surface of the slider, and the sunken rail includes one end that is blocked and the other end connected to the side surface of the slider main body to allow the air flow incoming through the sunken rail to exit outside the slider main body.

11. The slider of claim 10, wherein a head mounting unit is further formed at the center of the lower surface of the slider main body in a lengthwise direction of the slider and has an end portion on which the read/write head is mounted, and the air bearing unit is symmetrically provided at both sides of the lower surface of the slider main body with respect to the head mounting unit.

12. A hard disk drive comprising:
a disk on and from which data is recorded and reproduced; and
a slider comprising a slider main body on which a read/write head is mounted, the read/write head configured to write data to a disk and to read data from the disk by being lifted a predetermined height from a surface of the disk by a lift force when the disk is rotating, and a lift force generation unit provided in an area of the slider main body proximate to the read/write head to improve the lift force of the slider main body with respect to the disk.

13. The hard disk drive of claim 12, wherein the lift force generation unit is provided at a leading end farther than the read/write head with respect to the slider main body.

14. The hard disk drive of claim 12, wherein a lower surface of the lift force generation unit is substantially flat to increase a contact surface with an air flow generated during the rotation of the disk.

15. The hard disk drive of claim 14, wherein the lower surface of the lift force generation unit and a lower surface of the slider main body are substantially parallel to each other.

16. The hard disk drive of claim 15, wherein the height from a surface of the disk to the lowest end side of the lift force generation unit is greater than that from the surface of the disk to the lowest end side of the slider main body.

17. The hard disk drive of claim 16, wherein a minimal separation distance H in a vertical direction between the lower surface of the slider main body and the lower surface of the lift force generation unit is calculated by an equation that:
H=L×tan θ,
wherein “θ” is an angle between a lower surface of the slider and a horizontal surface of the disk assuming that the read/write head contacts the disk and “L” is a length of the lift force generation unit in a lengthwise direction of the slider.

18. The hard disk drive of claim 12, wherein the lift force generation unit is integrally formed in the slider main body.

19. The hard disk drive of claim 12, wherein the lift force generation unit is coupled to the slider main body to provide an auxiliary lift force.

20. The hard disk drive of claim 12, wherein an air bearing unit is formed on the lower surface of the slider main body to assist the lift of the slider main body as the air flow is generated during the rotation of the disk.

21. The hard disk drive of claim 20, wherein the air bearing unit is formed by a sunken rail of a non-linear type that is sunken in the widthwise direction of the slider main body from the lower surface of the slider, and the sunken rail includes one end that is blocked and the other end connected to the side surface of the slider main body to allow the air flow incoming through the sunken rail to exit outside the slider main body.

22. The hard disk drive of claim 21, wherein a head mounting unit is further formed at the center of the lower surface of the slider main body in a lengthwise direction of the slider and has an end portion on which the read/write head is mounted, and the air bearing unit is symmetrically provided at both sides of the lower surface of the slider main body with respect to the head mounting unit.

23. A head stack assembly (HSA) of a hard disk drive, the HSA comprising:
a read/write head to read data from a disk and to write data to the disk;
a slider connected to the read/write head to receive a lift force of the disk to lift the read/write head above the disk when the disk is rotating; and
a lift force generation unit coupled to the slider to provide an auxiliary lift force of the disk to the slider when the rotation of the disk decelerates.

24. The HSA of claim 23, wherein:
the lift force generation unit provides the auxiliary lift force as the read/write head moves closer to the disk.

25. The HSA of claim 23, wherein:
the lift force generation unit does not substantially change the lift force when the read/write head is disposed a predetermined height above the disk.

26. The HSA of claim 23, wherein:
the slider forms a first angle with respect to the disk when the disk is rotating at a predetermined speed such that the lift force generation unit does not substantially change the lift force received by the slider; and
the slider forms a second angle with respect to the disk when the disk is rotating at a speed less than the predetermined speed such that the lift force generation unit changes the lift force by providing the auxiliary lift force to the slider.
